(19) United States
(12) Patent Application Publication
(10) Pub. No.: US 2026/0233735 A1
(43) Pub. Date: Aug. 13, 2026

(54) COLLISION PREDICTION DEVICE AND COLLISION PREDICTION METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kento OISHI, Tokyo (JP); Shimpei HIGASHINO, Atsugi-shi (JP)

(21) Appl. No.: 19/535,803

(22) Filed: Feb. 10, 2026

(30) Foreign Application Priority Data
Feb. 13, 2025 (JP) 2025-021373

(51) Int. Cl. B60W 30/095; B60W 50/00

(52) U.S. Cl. CPC B60W 30/0956; B60W 50/0097; B60W 2554/4045; B60W 2554/801

(57) ABSTRACT

A collision prediction device for predicting a collision between a mobile object and a target object detected by a sensor mounted to the mobile object includes: a path prediction unit configured to predict a first travelling path that is a path of the mobile object and a second travelling path that is a path of the target object, a determination unit configured to determine, when the mobile object turns, whether the mobile object and the target object travel parallel with each other, and a collision prediction unit configured to predict whether the mobile object and the target object will collide based on the predicted first travelling path and the predicted second travelling path. The collision prediction unit is configured to predict that the mobile object and the target object will not collide in a case that it is determined that the mobile object and the target object travel parallel with each other.

### CROSS-REFERENCE TO RELATED APPLICATIONS

This application is based on and claims the benefit of priority from Japanese Application No. 2025-21373, filed on Feb. 13, 2025. The contents of this application are incorporated herein by reference in their entirety.

### BACKGROUND

### 1. Technical Field

This disclosure relates to a collision prediction device and a collision prediction method.

### 2. Related Art

Various techniques for predicting vehicle collision have been proposed. Related to the techniques, JP2020008288A discloses a technique for predicting both a travelling path of an own vehicle and a travelling path of a target object in the surroundings of the own vehicle. In this technique, a collision between the own vehicle and the target object is predicted when the travelling paths intersect. The travelling path of the own vehicle is predicted based on a current position, a velocity, and an acceleration of the own vehicle, and the travelling path of the target object is predicted based on a current position and a velocity of the target object.

### SUMMARY

The present disclosure may be realized in the following embodiments.

According to an embodiment of the present disclosure, a collision prediction device is provided for predicting a collision between a mobile object and a target object detected by a sensor mounted to the mobile object. The collision prediction device comprises: a path prediction unit configured to predict a first travelling path that is a path of the mobile object and a second travelling path that is a path of the target object, a determination unit configured to determine, when the mobile object turns, whether the mobile object and the target object travel parallel with each other, and a collision prediction unit configured to predict whether the mobile object and the target object will collide based on the predicted first travelling path and the predicted second travelling path.

According to this embodiment, the collision prediction unit is configured to predict that the mobile object and the target object will not collide in a case that it is determined that the mobile object and the target object travel parallel with each other.

### BRIEF DESCRIPTION OF THE DRAWING

FIG. 1 is a block diagram showing the general configuration of the collision prediction device according to an embodiment of the present disclosure.

FIG. 2 is a diagram illustrating a state where an own vehicle and another vehicle are traveling parallel.

FIG. 3 is a diagram illustrating a distance in the turning radius direction.

FIG. 4 is a flowchart showing a collision prediction process during turning.

### DETAILED DESCRIPTION OF THE PREFERRED EMBODIMENTS

In the technology of JP2020008288A, it is concerned that collision prediction accuracy may decrease due to the travelling path of the target object traveling parallel with the turning own vehicle being incorrectly estimated. Specifically, since the travelling path of the target object is estimated based on the current position and the velocity of the target object, the target object may be estimated to travel straight even though it is turning while traveling parallel with the own vehicle. This may lead to an erroneous estimation that the vehicle and the target will collide. Therefore, there is room for improvement in collision prediction between the turning own vehicle and the target object traveling parallel. The present disclosure may be realized in the following embodiments.

According to an embodiment of the present disclosure, a collision prediction device is provided for predicting a collision between a mobile object and a target object detected by a sensor mounted to the mobile object. The collision prediction device comprises: a path prediction unit configured to predict a first travelling path that is a path of the mobile object and a second travelling path that is a path of the target object, a determination unit configured to determine, when the mobile object turns, whether the mobile object and the target object travel parallel with each other, and a collision prediction unit configured to predict whether the mobile object and the target object will collide based on the predicted first travelling path and the predicted second travelling path.

According to this embodiment, the collision prediction unit is configured to predict that the mobile object and the target object will not collide in a case that it is determined that the mobile object and the target object travel parallel with each other. This suppresses the erroneous prediction that the mobile object and the target object will collide when they turn in parallel with each other.

### A. Embodiment

### <overview of a Collision Prediction Device 1>

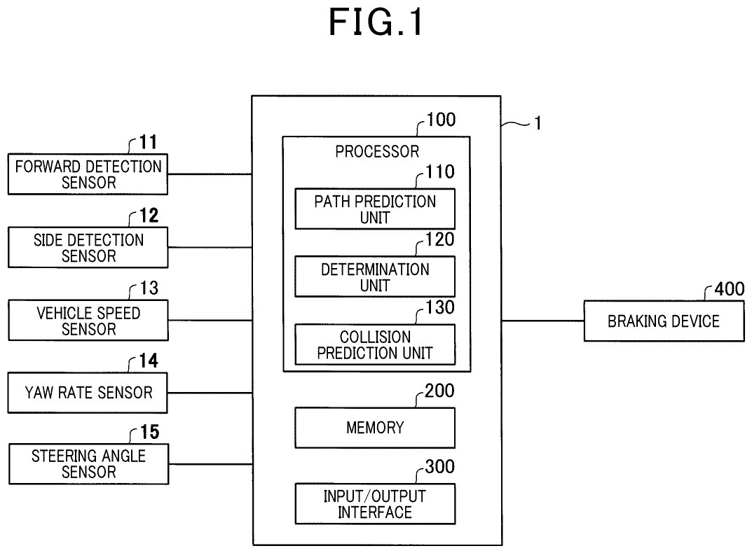

A collision prediction device 1 shown in FIG. 1 is mounted to a vehicle. The collision prediction device 1 predicts whether a vehicle and a target object will collide based on detection results of various sensors mounted to the vehicle. The vehicle is an example of a “mobile object”. The target object is an object existing the vehicle. Hereinafter, the vehicle on which the collision prediction device 1 is mounted may be referred to as an “own Vehicle”.

The term “target object” in this disclosure refers to the detection targets of the various sensors mounted to the vehicle. The target objects may include pedestrians, bicycles, animals, other vehicles besides the own vehicle, buildings, utility poles, and trees. Among these objects, those that are not immovable property and capable of moving are referred to as “mobile target objects”.

### <Configuration of Sensors>

As shown in FIG. 1, signals are transmitted from multiple sensors to the collision prediction device 1 via an input/output interface (I/F) 300. Multiple sensors shown in FIG. 1 are mounted to the vehicle in which the collision prediction device 1 is installed. The multiple sensors include a forward detection sensor 11, a side detection sensor 12, a vehicle speed sensor 13, a yaw rate sensor 14, and a steering angle sensor 15.

The front detection sensor 11 detects mobile objects existing in the area including ahead of the vehicle. The side detection sensor 12 detect mobile objects existing in the area including the side of the vehicle. “The side of the vehicle” may include diagonally front side and rear side of the vehicle. Each of the diagonally front side and rear side is within the range of 30 to 60 degrees from a center axis of the vehicle, that is aligned with the vehicle longitudinal direction (forward/reverse direction) and passing through the center of the lateral direction of the vehicle. Each of the front detection sensor 11 and the side detection sensor 12 may be, for example, cameras or ranging devices. The ranging device may be, for example, a millimeter-wave radar device or a LiDAR (Light Detection and Ranging). The front detection sensor 11 may be provided, for example, at the center of the front bumper of the vehicle. Two of the side detection sensors 12 may be provided, for example, at the left and right ends of the front bumper of the vehicle. The detection areas of the front detection sensor 11 and the side detection sensors 12 may partially overlap each other.

The vehicle speed sensor 13 outputs a signal corresponding to the running the speed of the vehicle. The vehicle speed sensor 13 may detect, for example, the rotational speed of tires of the vehicle. The signal output by the vehicle speed sensor 13 is used by the collision prediction device 1 to calculate the speed of the vehicle.

The yaw rate sensor 14 outputs a signal corresponding to the yaw rate of the vehicle. The signal output by the yaw rate sensor 14 is used by the collision prediction device 1 to calculate the yaw rate of the vehicle.

The steering angle sensor 15 outputs a steering angle signal corresponding to the steering angle of the vehicle to the collision prediction device 1. The steering angle sensor 15 is mounted to a steering rod of the vehicle.

### <Configuration of a Braking Device 400>

The braking device 400 outputs braking force to brake the vehicle. The braking device 400 outputs braking force based on either an instruction from an occupant or an instruction from the collision prediction device 1. The instruction from the occupant is given via an input operator such as a brake pedal. The instruction from the collision prediction device 1 is transmitted via an electrical signal.

### <Configuration of the Collision Prediction Device 1>

The collision prediction device 1 is provided with a processor 100, a memory 200, and an input/output interface 300. The collision prediction device 1 may be configured as part of an ECU (Electronic Control Unit) that performs various controls of the vehicle.

The processor 100 functions as a path prediction unit 110, a determination unit 120, and a collision prediction unit 130 by executing a program stored in the memory 200.

### <Function of the Path Prediction Unit 110>

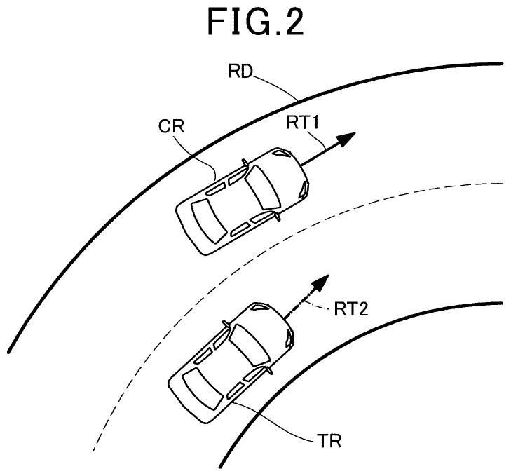

The path prediction unit 110 predicts the first travelling path, which is a travelling path of the own vehicle, and the second travelling path, which is a travelling path of the target object. The following describes an example where the target object is another vehicle in motion. As shown in FIG. 2, the own vehicle CR travels while turning along the curved road RD. The curved road RD has two lanes. The first travelling path RT1 is shown as a solid line. The other vehicle TR travels along the curved road RD while turning, moving parallel with the own vehicle CR in the same direction. The other vehicle TR travels in the lane adjacent to the lane CR is traveling in. The second travelling path RT2 is shown as a dashed line.

The path prediction unit 110 predicts the first travelling path RT1 based on the speed, the yaw rate, and the steering angle of the own vehicle CR. The speed of the own vehicle CR is calculated based on the signal acquired from the vehicle speed sensor 13 shown in FIG. 1. The yaw rate is calculated based on the signal acquired from the yaw rate sensor 14. The steering angle is calculated based on the signal acquired from the steering angle sensor 15.

The path prediction unit 110 predicts the second travelling path RT2 based on detection results from the front detection sensor 11 and the side detection sensor 12. For example, the path prediction unit 110 may predict the second travelling path RT2 based on changes in the position of the other vehicle TR detected by the front detection sensor 11 and the side detection sensor 12.

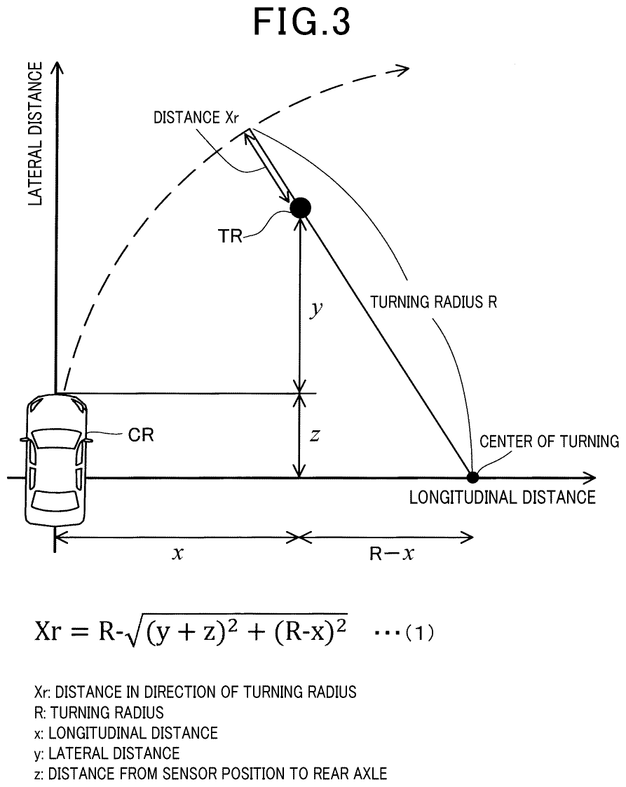

Furthermore, the path prediction unit 110 calculates a turning radius of the own vehicle CR when the mobile object turns and calculates a distance between the own vehicle CR and the other vehicle TR in the direction of the turning radius (a distance Xr described later). This distance calculation is explained using FIG. 3. FIG. 3 shows a bird's-eye view of the own vehicle CR turning to the right. For illustrative purposes, the other vehicle TR is simplified in FIG. 3. As shown in FIG. 3, the distance Xr is geometrically calculated based on the turning radius R of the own vehicle CR, a lateral distance x and a longitudinal distance y between the own vehicle CR and the other vehicle TR, and the distance z from the sensor position to the rear axle. The turning radius R is calculated based on the speed and the yaw rate of the own vehicle CR. The lateral distance x and longitudinal distance y are calculated based on the detection results from the front detection sensor 11 and side detection sensor 12. Information of the distance z from the sensor position to the rear axle is stored in the memory 200. The distance Xr is calculated by substituting these values into equation (1) shown in FIG. 3. The path prediction unit 110 stores the calculated distance Xr in the memory 200 along with a timestamp at which the distance Xr was calculated.

### <Function of the Determination Unit 120>

The determination unit 120 shown in FIG. 1 determines whether the own vehicle CR and the other vehicle TR are traveling parallel with each other when the own vehicle CR turns, based on the distance Xr calculated by the path prediction unit 110. More specifically, the determination unit 120 determines that the own vehicle CR and the other vehicle TR travels parallel with each other in a case that a change in the distance Xr in a predetermined period is less than a predetermined threshold. The determination unit 120 determines that the own vehicle CR and the other vehicle TR do not travel parallel with each other in a case that the change in the distance Xr is equal to or greater than the threshold. The predetermined period may be, for example, 1 second. The predetermined period is not limited to 1 second and may be set to any value. The predetermined threshold may be, for example, 50 cm. The predetermined threshold is not limited to 50 cm and may be set to any value. Information of the predetermined period and the predetermined threshold is stored in the memory 200. The determination unit 120 calculates the change in the distance Xr based on the distance Xr stored in the memory 200 along with the timestamp. More specifically, the determination unit 120 calculates the change in the distance Xr based on the latest distance Xr calculated by the path prediction unit 110 and the distance Xr with the timestamp which differs (is earlier than) by the predetermined period from the timestamp corresponding to the latest distance Xr. Then the determination unit 120 determines whether the change in the distance Xr is less than the threshold. When the change in the distance Xr is less than the threshold distance Xr is below the threshold, i.e., in a case that the change in the distance Xr is relatively small, the determination unit 120 determines that the own vehicle CR and the other vehicle TR travel parallel with each other. On the other hand, in a case that the change in the distance Xr is equal to or greater than the threshold, i.e., in a case that the change in the distance Xr is relatively large, the determination unit 120 determines that the own vehicle CR and the other vehicle TR do not travel parallel with each other.

### <Function of the Collision Prediction Unit 130>

The collision prediction unit 130 predicts whether the own vehicle CR and the other vehicle TR will collide based on the first travelling path RT1 and the second travelling path RT2. Specifically, the collision prediction unit 130 predicts whether the own vehicle CR and the other vehicle TR will collide by determining whether the first travelling path RT1 and the second travelling path RT2 intersect. When the collision prediction unit 130 predicts the own vehicle CR and the other vehicle TR collide, the collision prediction unit 130 instructs the braking device 400 to apply braking force to the own vehicle CR. This suppresses occurrence of collision between the own vehicle CR and the other vehicle TR.

The collision prediction unit 130 of the present disclosure predicts that the own vehicle CR and the other vehicle TR will not collide in a case that it is determined that they travel parallel with each other, regardless of whether the first travelling path RT1 and the second travelling path RT2 intersect. That is, even in a case that it is determined that the first travelling path RT1 and the second travelling path RT2 intersect, the collision prediction unit 130 predicts that the own vehicle CR and the other vehicle TR will not collide in a case that it is determined that the own vehicle CR and the other vehicle TR travel parallel with each other. This suppresses the erroneous prediction that the own vehicle CR and the other vehicle TR will collide when they are traveling parallel with each other.

### <Collision Prediction Process During Turning>

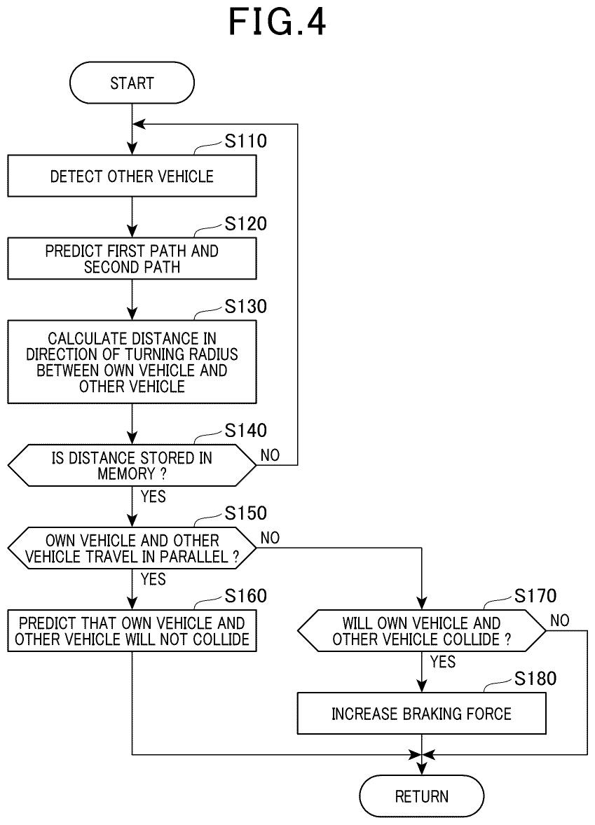

The collision prediction process shown in FIG. 4 is performed when the own vehicle CR starts to turn. The collision prediction processing is repeatedly performed while the own vehicle CR is turning. The side detection sensor 12 detects the other vehicle TR (Step S110). Hereafter, “Step S” is simply represented as “S”.

The path prediction unit 110 predicts the first travelling path RT1 of the own vehicle CR and the second travelling path RT2 of the other vehicle TR (S120). The path prediction unit 110 also calculates the radial distance Xr between the own vehicle CR and the other vehicle TR in the turning radius direction (S130). The information of the predicted distance Xr is stored in the memory 200. The processes in S120 and S130 may be performed in parallel.

The determination unit 120 determines whether information of the distance Xr predicted prior to the current time point is stored in the memory 200 (S140). In a case that the distance Xr predicted prior to the current time point is not stored in the memory 200 (S140: NO), i.e., in a case that the distance Xr to the other vehicle TR is calculated for the first time, the process returns to S110. In a case that the distance Xr predicted prior to the current time points stored in memory 200 (S140: YES), i.e., in a case that the distance Xr at a point prior to the current time point has already been calculated and stored in the memory 200, the determination unit 120 determines whether the own vehicle CR and the other vehicle TR travel parallel with each other (S150). More specifically, the determination unit 120 calculates the change in the distance Xr based one the latest distance Xr calculated in S130 and the distance Xr stored in memory 200 at a previous time point. The distance Xr at the previous time point used here is the distance predicted at a time point such that the period between that point and the point at which the latest distance Xr was predicted is the predetermined period. The determination unit 120 determines that the own vehicle CR and the other vehicle TR travel parallel with each other in a case that the calculated change amount is less than the predetermined threshold, and determines that the own vehicle CR and the other vehicle TR do not travel parallel with each other in a case that the calculated change amount is equal to or greater than the predetermined threshold.

In a case that it is determined that the own vehicle CR and the other vehicle TR travel parallel with each other (S150: YES), the collision prediction unit 130 predicts that the own vehicle CR and the other vehicle TR will not collide (S160). Following S160, the process returns to S110.

In a case that it is determined that the own vehicle CR and the other vehicle TR do not travel parallel with each other (S150: NO), the collision prediction unit 130 predicts whether the own vehicle CR and the other vehicle TR will collide (S170). In a case that it is predicted that the own vehicle CR and the other vehicle TR will collide (S170: YES), the collision prediction unit 130 transmits a control signal to the braking device 400 to increase the braking force (S180). In a case that it is predicted that the own vehicle CR and the other vehicle TR will not collide (S170: NO), the process returns to S110.

According to the collision prediction device 1 of the described embodiment, the collision prediction unit 130 predicts that the own vehicle CR and the other vehicle TR will not collide in a case that it is determined that they travel parallel with each other. Therefore, it suppress the erroneous prediction of a collision between the own vehicle CR and the other vehicle TR when they are turning while traveling parallel with each other.

Furthermore, according to the collision prediction device 1 of the embodiment, the determination unit 120 determines whether the own vehicle CR and the other vehicle TR travel parallel with each other based one the distance Xr between the own vehicle CR and the other vehicle TR in the turning radius direction, as calculated by the path prediction unit 110. Therefore, compared to a configuration using a simple straight-line distance between the own vehicle CR and the other vehicle TR, it is possible to perform determination process using more precise positional relationship between the turning own vehicle CR and the other vehicle TR. This suppresses erroneous prediction of a collision.

Furthermore, according to the collision prediction device 1 of the embodiment, the determination unit 120 determines that the own vehicle CR and the other vehicle TR travel parallel with each other in a case that the change in the distance Xr in the predetermined period is less than the predetermined threshold, and determines that the own vehicle CR and the other vehicle TR do not travel parallel with each other when the change in distance Xr is equal to or greater than the predetermined threshold. Therefore, by setting an appropriate threshold, the determination of travelling parallel is performed with high accuracy.

### B. Another Embodiments

(B1) In the above embodiment, the determination unit 120 may calculate the change in distance Xr based on the distance Xr at any first time point and the distance Xr at a second time point after the first time point. The first time point may be, for example, the timing when the own vehicle CR begins turning. The first time point may also be, for example, the timing when the other vehicle TR is first detected. Furthermore, the determination unit 120 may set the threshold larger as the distance Xr at the first time point is larger. According to this configuration, when the distance Xr is relatively large, indicating a relatively low possibility of collision between the own vehicle CR and the other vehicle TR, the threshold is set with a margin. This reduces the number of times the collision prediction unit 130 performs collision prediction calculations for the own vehicle CR and the other vehicle TR.
(B2) In the above embodiment, the determination unit 120 determines whether the own vehicle CR and the other vehicle TR travel parallel with each other based on the distance Xr, but the present disclosure is not limited to this configuration. The determination unit 120 may, for example, perform the determination of traveling parallel with each other based on the straight-line distance between the own vehicle CR and the other vehicle TR. In such a configuration, the determination unit 120 determines that the vehicles CR and TR travel parallel with each other in a case that the change in the straight-line distance in a predetermined time period is less than a threshold, and determines that they do not travel parallel with each other in a case that the change in the straight-line distance in the predetermined time period is equal to or greater than the threshold value. This configuration also enables determination of whether the own vehicle CR and the other vehicle TR travel parallel with each other.
(B3) In the above embodiment, the target object is the other vehicle TR, but the present disclosure is not limited to this configuration. The target object may be any mobile object. Furthermore, the collision prediction device 1 is mounted to a vehicle, but the present disclosure is not limited to this configuration. The collision prediction device 1 may be mounted to any mobile object. The mobile object may be, for example, a ship, an airplane, or a so-called flying car.
(B4) In the above embodiment, the determination unit 120 determines that the own vehicle CR and the other vehicle TR traveling parallel with each other in a case that the change in distance Xr in the predetermined period is less than the predetermined threshold, and determines that the own vehicle CR and the other vehicle TR do not travel parallel with each other in a case that the change in distance Xr in the predetermined period is equal to or greater than the predetermined threshold. However, the present disclosure is not limited to this configuration. The determination unit 120 may determine that the own vehicle CR and the other vehicle TR travel parallel with each other in a case that the change in distance Xr in the predetermined period is less than or equal to a predetermined threshold, and determine that the own vehicle CR and the other vehicle TR do not travel parallel with each other in a case that the change in distance Xr in the predetermined period is greater than the predetermined threshold.
(B5) The collision prediction device 1 and methods described herein may be implemented by a dedicated computer provided by configuring a processor and memory programmed to execute one or more functions embodied by a computer program. Alternatively, the collision prediction device 1 and methods described herein may be implemented by a dedicated computer provided by configuring a processor using one or more dedicated hardware logic circuits. Alternatively, the collision prediction device 1 and methods described herein may be implemented by one or more dedicated computers configured with a combination of a processor and memory programmed to execute one or more functions, and one or more hardware logic circuits. Furthermore, the computer program may be stored on a computer-readable, non-transitory tangible medium as instructions executable by a computer.

The present disclosure is not limited to the embodiments described above and may be realized in various configurations within the scope of the invention without departing from its spirit. For example, the technical features in each embodiment corresponding to the technical features described in the Summary of the Invention may be appropriately substituted or combined to solve some or all the above-mentioned problems or to achieve some or all the above-mentioned effects. Furthermore, if a technical feature is not described herein as essential, it may be omitted as appropriate. This disclosure may be embodied, for example, in the form of a collision prediction method, a computer program for implementing such a method, or a non-transitory storage medium recording such a computer program.

The present disclosure may be embodied, for example, in the following forms.

### Form 1

A collision prediction device for predicting a collision between a mobile object and a target object detected by a sensor mounted to the mobile object, the collision prediction device comprising:
a path prediction unit configured to predict a first travelling path that is a path of the mobile object and a second travelling path that is a path of the target object;
a determination unit configured to determine, when the mobile object turns, whether the mobile object and the target object travel parallel with each other; and
a collision prediction unit configured to predict whether the mobile object and the target object will collide based on the predicted first travelling path and the predicted second travelling path, wherein
the collision prediction unit is configured to predict that the mobile object and the target object will not collide in a case that it is determined that the mobile object and the target object travel parallel with each other.

### Form 2

The collision prediction device according to Form 1, wherein
when the mobile object turns, the path prediction unit is configured to calculate a turning radius of the mobile object and a distance between the mobile object and the target object in the direction of the predicted turning radius, and
the determination unit is configured to determine whether the mobile object and the target object travel parallel with each other based on the distance.

### Form 3

The collision prediction device according to Form 1, wherein
when the mobile object turns, the path prediction unit is configured to calculate a turning radius of the mobile object and a distance between the mobile object and the target object in the direction of the predicted turning radius, and
the determination unit configured to determine whether the mobile object and the target object travel parallel with each other based on a change in the distance.

### Form 4

The collision prediction device according to Form 1, wherein
the determination unit is configured to determine that the mobile object and the target travel parallel with each other in a case that an amount of the change in the distance is less than a predetermined threshold and determine that the mobile object and the target do not travel parallel with each other in a case that the amount of the change in the distance is equal to or greater than the predetermined threshold.

### Form 5

The collision prediction device according to Form 4, wherein,
the determination unit is configured to calculate the change in the distance based on the distance at a first time point and the distance at a second time point, the second time point being after the first time point and set the threshold to a greater value as the distance at the first time point is greater.

### Form 6

A collision prediction method performed by a collision prediction device for predicting a collision between a mobile object and a target object detected by a sensor mounted to the mobile object, the collision prediction method comprising:
predicting a first travelling path that is a path of the mobile object and a second travelling path that is a path of the target object;
determining, when the mobile object turns, whether the mobile object and the target object travel parallel with each other; and
predicting whether the mobile object and the target object will collide based on the predicted first travelling path and the predicted second travelling path, wherein
the prediction includes predicting that the mobile object and the target object will not collide in a case that it is determined that the mobile object and the target object travel parallel with each other.

### Form 7

A collision prediction device for predicting a collision between a mobile object and a target object detected by a sensor mounted to the mobile object, the collision prediction device comprising a processor and memory storing instructions,
wherein the processor is configured to execute the instructions to perform:
   predicting a first travelling path that is a path of the mobile object and a second travelling path that is a path of the target object;
   determining, when the mobile object turns, whether the mobile object and the target object travel parallel with each other; and
   predicting whether the mobile object and the target object will collide based on the predicted first travelling path and the predicted second travelling path,
wherein the prediction includes predicting that the mobile object and the target object will not collide in a case that it is determined that the mobile object and the target object travel parallel with each other.

What is claimed is:

1. A collision prediction device for predicting a collision between a mobile object and a target object detected by a sensor mounted to the mobile object, the collision prediction device comprising:
a path prediction unit configured to predict a first travelling path that is a path of the mobile object and a second travelling path that is a path of the target object;
a determination unit configured to determine, when the mobile object turns, whether the mobile object and the target object travel parallel with each other; and
a collision prediction unit configured to predict whether the mobile object and the target object will collide based on the predicted first travelling path and the predicted second travelling path, wherein
the collision prediction unit is configured to predict that the mobile object and the target object will not collide in a case that it is determined that the mobile object and the target object travel parallel with each other.

2. The collision prediction device according to claim 1, wherein
when the mobile object turns, the path prediction unit is configured to calculate a turning radius of the mobile object and a distance between the mobile object and the target object in the direction of the predicted turning radius, and
the determination unit is configured to determine whether the mobile object and the target object travel parallel with each other based on the distance.

3. The collision prediction device according to claim 1, wherein
when the mobile object turns, the path prediction unit is configured to calculate a turning radius of the mobile object and a distance between the mobile object and the target object in the direction of the predicted turning radius, and
the determination unit configured to determine whether the mobile object and the target object travel parallel with each other based on a change in the distance.

4. The collision prediction device according to claim 3, wherein
the determination unit is configured to determine that the mobile object and the target travel parallel with each other in a case that an amount of the change in the distance is less than a predetermined threshold and determine that the mobile object and the target do not travel parallel with each other in a case that the amount of the change in the distance is equal to or greater than the predetermined threshold.

5. The collision prediction device according to claim 4, wherein,
the determination unit is configured to calculate the change in the distance based on the distance at a first time point and the distance at a second time point, the second time point being after the first time point and set the threshold to a greater value as the distance at the first time point is greater.

6. A collision prediction method performed by a collision prediction device for predicting a collision between a mobile object and a target object detected by a sensor mounted to the mobile object, the collision prediction method comprising:
predicting a first travelling path that is a path of the mobile object and a second travelling path that is a path of the target object;
determining, when the mobile object turns, whether the mobile object and the target object travel parallel with each other; and
predicting whether the mobile object and the target object will collide based on the predicted first travelling path and the predicted second travelling path, wherein
the prediction includes predicting that the mobile object and the target object will not collide in a case that it is determined that the mobile object and the target object travel parallel with each other.
